(19) United States
(12) Patent Application Publication
(10) Pub. No.: US 2009/0323747 A1
(43) Pub. Date: Dec. 31, 2009

(54) ORGANIC SOLID-STATE DYE LASER

(76) Inventors: Hajime Nakanotani, Chitose-shi (JP); Chihaya Adachi, Chitose-shi (JP)

Correspondence Address: MASAO YOSHIMURA, CHEN YOSHIMURA LLP, 333 W. El Camino Real, Suite 380, Sunnyvale, CA, 94087, US

(21) Appl. No.: 12/065,898

(22) PCT Filed: Sep. 5, 2006
(86) PCT No.: PCT/JP2006/317582

§ 371 Date: Jul. 29, 2009

(30) Foreign Application Priority Data
Sep. 6, 2005 (JP) 2005-258587

(51) Int. Cl. H01S 3/16; C09K 11/06

(52) U.S. Cl. 372/43.01

(57) ABSTRACT

An organic solid-state dye laser (1) is disclosed comprising a substrate (2) and a resonator structure made of a thin film of organic semiconductor (3) formed on the substrate (2) wherein the thin film of organic semiconductor (3) is composed of an organic semiconductor material which is high in emission quantum yield and substantially devoid of excitation absorption at an excitation level and includes one of a bis-styryl derivative or a triphenylamine derivative whereby its amplified spontaneous emission under excitation light irradiation is continuously obtained. The thin film of organic semiconductor (2) may be of a material having BSB-Cz or TPD added to a host molecule of CBP and capable of amplified spontaneous emission at a threshold value as low as 3 mW.

### TECHNICAL FIELD

The present invention relates to an organic solid-state dye laser whereby its amplified spontaneous emission is generated by an external excitation light.

### BACKGROUND ART

Light emitting devices composed of an organic semiconductor have attracted attention as a spontaneous light-emitting device and putting them to practical use is now in progress. Further, research and development of lasers composed of an organic semiconductor are also being advanced. Injecting an excitation light externally into a thin film composed of an organic semiconductor gives rise to its amplified spontaneous emission (hereinafter, referred to also as “ASE” conveniently). The smaller the energy per unit area, namely, the threshold value (hereinafter, referred to also as “Eₜₕ” conveniently), of an external light injected into the organic semiconductor when generating its ASE, the better material it may be.

Photophysical parameters for giving rise to an ASE with an organic semiconductor can be listed as quantum efficiency, radiative decay rate (kᵣ) derived from emission lifetime and the like. Parameter kᵣ has been considered to be proportional to an oscillator strength (OS) derived from an area of absorption spectrum.

As a material used for a laser active layer, styrylbenzene derivative and the like which exhibit a low threshold value of ASE have so far been investigated. Especially, a thin film of CBP (4,4′-N,N′-dicarbazole-biphenyl) doped in 6% by weight with a fluorescent material of styrylbenzene family (SBD), and bis-styrylbenzene (BSB) derivative of dimer skeleton as the skeleton exhibiting an especially low threshold value were found out. And it has been reported by the present inventors that they have an excellent ASE properties (see Non-patent References 1 and 2).

Especially, it has been reported by the present inventors that 4,4′-bis[(N-carbazole)styryl]biphenyl (BSB-Cz) has its quantum efficiency Φ_{PL} and the radiation deactivation velocity constant kᵣ which are as extremely high as Φ_{PL}=99±1% and kᵣ=1×10⁹ s⁻¹ and that it allows its ASE emission when excited under pulsed laser light having its excitation light intensity which is as extremely low as its emission threshold E_{ASE}=0.32±0.1 μJ/cm² (see Non-patent Reference 2).

Non-patent Reference 1: Hajime Nakanotani et al., 52nd Extended Abstracts, Japan Society of Applied Physics and Related Societies, No. 3, 1a-YG-5, p. 1490; and

Non-patent Reference 2: T. Aimono et al., Appl. Phys. Lett. 86, 071110 (2005).

### DISCLOSURE OF THE INVENTION

### Problems to be Solved by the Invention

However, no organic solid-state dye laser for excitation by external light of low energy with continuous waves (CW) has been realized as yet. Presumably, this has been considered largely due to the existence of excited state absorption in the singlet or triplet excited state of an organic semiconductor.

In view of the problem mentioned above, it is an object of the present invention to provide an organic solid-state dye laser which is capable of continuous oscillation when it is excited by irradiation with continuous excitation light of a He—Cd laser, CW ultraviolet semiconductor laser, xenon lamp or the like.

### Means for Solving the Problem

As a result of their zealous researches, the present inventors have come to acquire the knowledge that an organic semiconductor material, i. e. in the form of a thin film, which is substantially without loss due to excited state absorption in singlet or triplet excited state thereof, i. e. in which there is no excitation absorption in an excitation level thereof, can generate an amplified spontaneous emission under continuous light excitation, and to accomplish the present invention.

In order to achieve the object mentioned above, there is provided in accordance with the present invention an organic solid-state dye laser which comprises a substrate and a resonator structure made of a thin film of organic semiconductor formed on the substrate, characterized in that the thin film of organic semiconductor is composed of an organic semiconductor material which is high in emission quantum yield and substantially devoid of excitation absorption at an excitation level and includes one of a bis-styryl derivative expressed by general formula (1) and a triphenylamine derivative expressed by general formula (2), whereby its amplified spontaneous emission under excitation light irradiation is continuously obtained wherein:

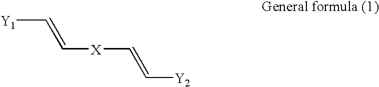

where Y₁, X and Y₂ are each a substituent of an aromatic or aliphatic compound, and

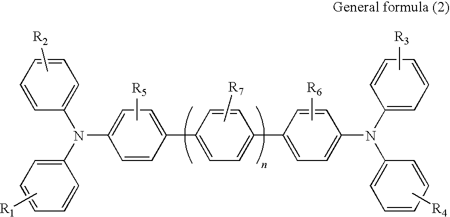

where R₁ to R₇ are each an alkyl radical and n is an integer of 0 or over.

In the structure mentioned above, the resonator structure made of the thin film of organic semiconductor is preferably constituted by a waveguide or a diffraction grating.

The bis-styryl derivative is preferably BSB-Cz (4,4′-bis[(N-carbazole)styryl]biphenyl), and the triphenylamine derivative is preferably TPD (N,N′-diphenyl-N,N′-(3-methylphenyl)-1,1′-biphenyl)-4,4′-diamine). The bis-styryl derivative or triphenylamine derivative is preferably added to a host molecule. The host molecule is preferably CBP (4,4′-N,N′-dicarbazole-biphenyl).

According to the structure mentioned above, it is possible to provide an organic solid-state dye layer which when excited by a light source of continuous waves is capable of generating amplified spontaneous emission.

### Effects of the Invention

According to the present invention, an organic solid-state dye laser of a simple structure is provided that is capable of an amplified spontaneous emission when excited by an external excitation light of low-energy continuous waves.

### BRIEF DESCRIPTION OF THE DRAWINGS

FIG. 1 is a diagrammatic perspective view illustrating the structure of an organic solid-state dye laser according to the present invention;

FIG. 2 is a perspective view diagrammatically illustrating a resonator structure of a laser medium body shown in FIG. 1;

FIG. 3 is a partial cross sectional view of a diffraction grating taken along the direction X-X in FIG. 2;

FIG. 4 is a perspective view diagrammatically illustrating a modified resonator structure of the laser medium body shown in FIG. 2;

FIG. 5 is a diagrammatic view illustrating a resonator structure of the laser medium body shown in FIG. 1;

FIG. 6 is a partial cross sectional view of a circular diffraction grating taken along the direction X-X in FIG. 5;

FIG. 7 is a view diagrammatically illustrating an equipment for measuring excitation absorption characteristics of BSB-Cz and TPD;

FIG. 8 is a graph illustrating light absorption cross section σ_{abs}, stimulated emission cross section σₑₘ and excitation absorption characteristics at an excitation level of BSB-Cz used in Example 1;

FIG. 9 is a graph illustrating excitation absorption characteristics at an excitation level of TPD used in Example 2;

FIG. 10 is a graph illustrating an absorption light characteristic of an organic solid-state dye laser of a film thickness of 100 nm in Example 1, its photoluminescence spectrum and its emission spectrum under external excitation light;

FIG. 11 is a graph illustrating dependence upon excitation light intensity, of emission light intensity of the organic solid-state dye laser having a film thickness of 100 nm in Example 1 under pulsed excitation by a nitrogen gas laser;

FIG. 12 is a graph illustrating emission spectra of an organic solid-state dye laser of varied film thicknesses in Example 1, excited by external light;

FIG. 13 is a graph illustrating emission spectra of an organic solid-state dye laser of a film thickness of 500 nm in Example 1, excited by external light;

FIG. 14 is a graph illustrating dependence upon excitation light intensity of emission light intensity of an organic solid-state dye laser of a film thickness of 500 nm in Example 1 under excitation by a He—Cd continuous wave laser;

FIG. 15 is a graph illustrating dependence of emission light intensity upon excitation light intensity at a further higher excitation intensity side;

FIG. 16 is a view diagrammatically illustrating a method of measuring polarization characteristics;

FIG. 17 is a graph illustrating polarization characteristics of ASE of an organic solid-state dye laser of a film thickness of 500 nm in Example 1 under excitation by a He—Cd continuous wave laser;

FIG. 18 is a graph illustrating dependence upon excitation light intensity of emission light intensity of the organic solid-state dye laser in Example 2 excited by the He—Cd continuous wave laser; and

FIG. 19 shows emission spectra of the organic solid-state dye laser in Example 2 shown in FIG. 18 when the excitation light intensity is (A) 210 mW/cm² and (B) 20950 mW/cm² (about 21 W/cm²), respectively.

### DESCRIPTION OF THE REFERENCE CHARACTERS

1: organic solid-state dye laser

2: substrate

3: thin film of organic semiconductor

3A, 3D: convex portion

3B, 3E: recessed portion

3C: convex portion of diameter R

10, 10A, 10B, 10C: laser medium body

11: excitation light

12: laser light

15: excitation light source unit

16: excitation light source

17: attenuator

18: shutter

19: lens

20: measuring equipment for excitation absorption characteristics

21: specimen

22: reference light source

23: excitation light source

24: spectrometer

25: detecting means

30: optical path of light generating from ASE

31: polarizer

32: polarized ASE light

### BEST MODES FOR CARRYING OUT THE INVENTION

The present invention will be described hereinafter with respect to forms of implementation thereof with reference to the Drawing Figures in which the same reference characters are used to designate the same or corresponding components.

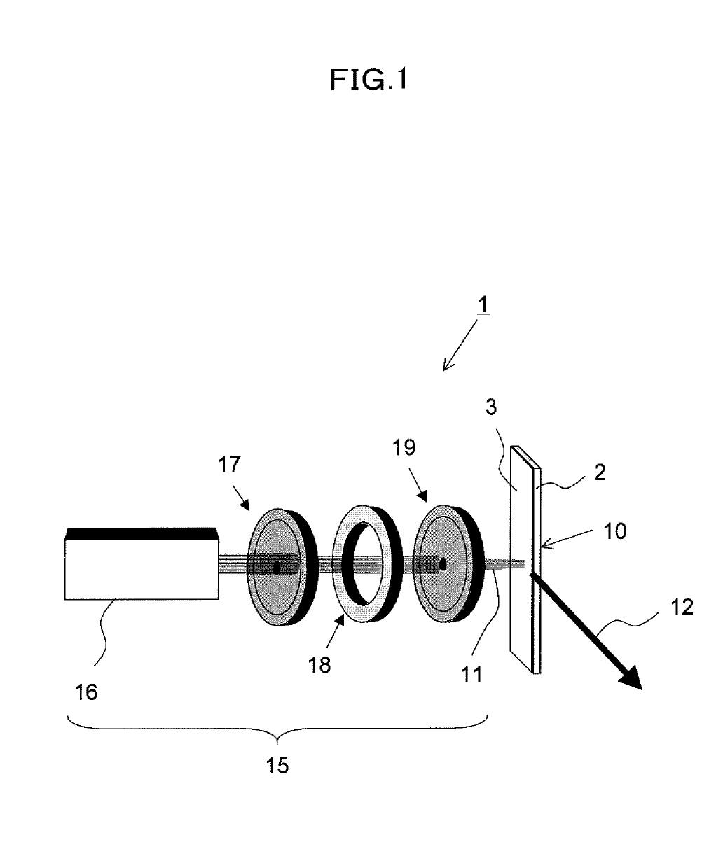

FIG. 1 is a diagrammatic perspective view illustrating the structure of an organic solid-state dye laser according to the present invention. As shown in FIG. 1, the organic solid-state dye laser, 1, is constituted of a laser medium body 10 made of a thin film of organic semiconductor 3 formed on a substrate 2, and an excitation light source unit 15. The laser medium body 10 made of the thin film of organic semiconductor 3 has a resonator structure constituted of a diffraction grating or a waveguide.

The structure of a waveguide can be made up of the thin film organic semiconductor 3 set at a preselected film thickness t. For example, setting the thickness t at 100 nm to 10 μm provides a waveguide structure.

Mention is made of the resonator structure using a diffraction grating.

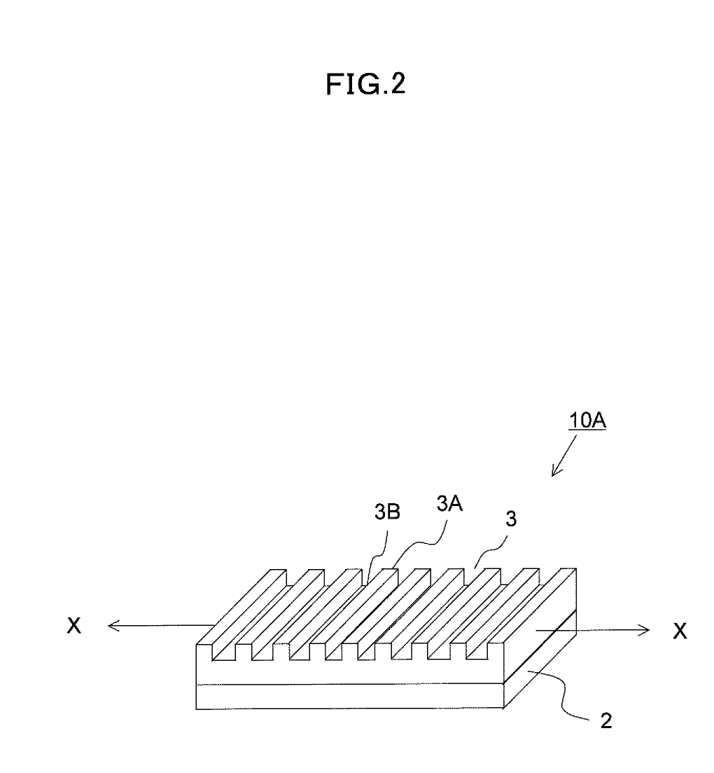

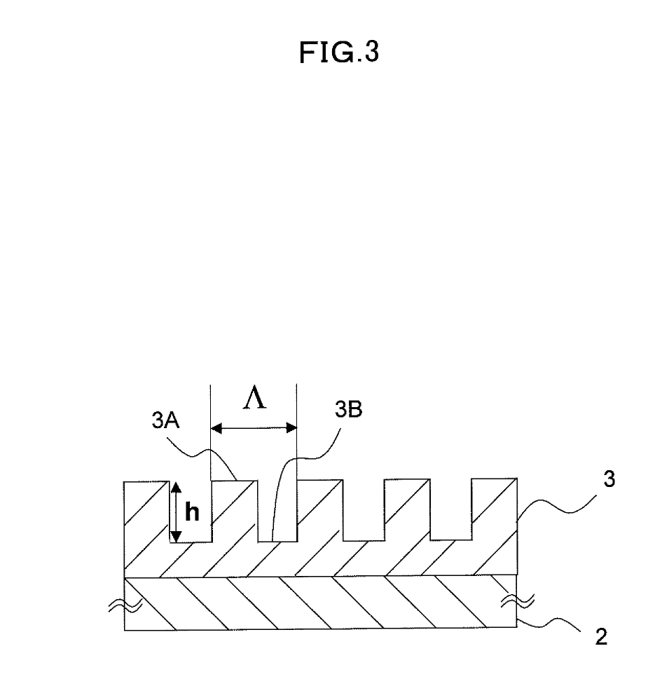

FIG. 2 is a perspective view diagrammatically illustrating the resonator structure of the laser medium body 10 shown in FIG. 1, and FIG. 3 is a partial cross sectional view of the diffraction grating taken along the direction X-X in FIG. 2.

As shown in FIG. 2, the thin film of organic semiconductor 3 formed on the substrate 2 in the laser medium body, 10A, has the resonator structure that is of distributed feedback (hereinafter, referred to as “DFB” conveniently) type, consisting of the diffraction grating. As shown in FIG. 3, the diffraction grating has a period Λ that is the sum in width of a convex portion 3A and a recessed portion 3B of a depth h. The period Λ of this diffraction grating of the DFB resonator may be set according to a desired oscillation frequency, and the depth h may be set at a value selected from 2 to 100 nm.

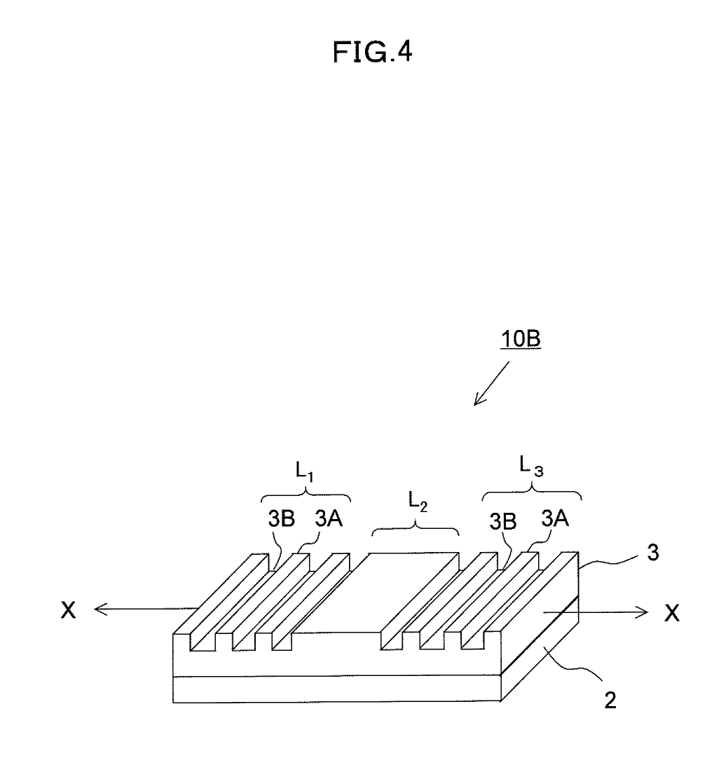

FIG. 4 is a perspective view diagrammatically illustrating a modified resonator structure of the laser medium body of the present invention. As shown in FIG. 4, the thin film of organic semiconductor 3 formed on the substrate 2 in the laser medium body, 10B, has the resonator structure which is called distributed Bragg reflector (hereinafter referred to as “DBR” conveniently) type, having a diffraction grating provided at each of its opposite ends as shown in FIG. 3. As shown in FIG. 4, L1 and L3 at the opposite ends provide a reflector and L2 at the center provides a gain area. The period Λ of the grating of this DBR resonator may be set according to a desired oscillation frequency.

Laser light in the DFB or DBR resonator structure generates in the directions X in FIGS. 2 and 4.

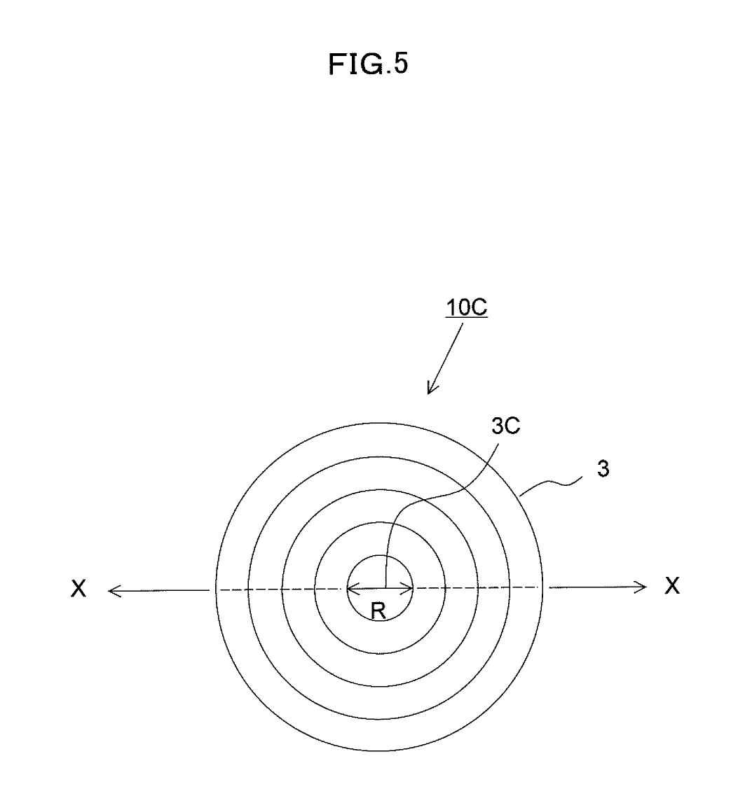

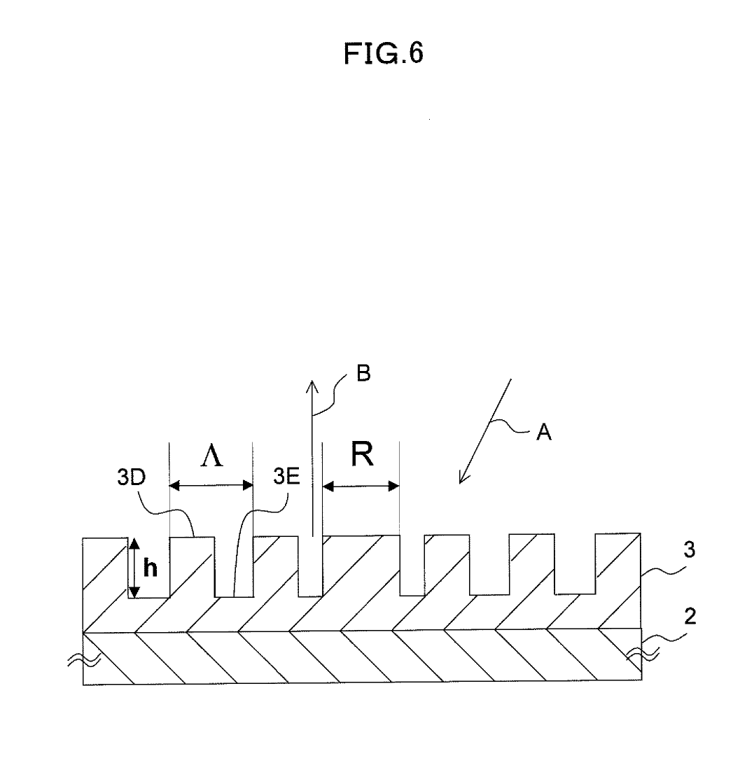

FIG. 5 is a diagrammatic view illustrating a resonator structure other than in the laser medium body 10A mentioned above. FIG. 6 is a partial cross sectional view of a circular diffraction grating taken along the direction X-X in FIG. 5.

As shown in FIG. 5, the thin film of organic semiconductor 3 formed on the substrate 2 in the laser medium body 10C is modified to form a circular diffraction grating around a convex portion 3C of diameter R about its center. As shown in FIG. 6, the diffraction grating has a period Λ which is the sum in width of an annular convex portion 3D and an annular recessed portion 3A of depth h. The period Λ of this diffraction grating may be set according to a desired oscillation frequency, and the depth h may be set at a value selected from 2 to 100 nm. Further, the diameter of the convex portion 3C may be set at one half of or twice the period Λ. A resonator structure using such a circular diffraction grating is capable of restraining continuous waves from being guided towards the resonator's ends. If an excitation light is injected into a thin film of organic semiconductor 3 from its front side (see the arrow A in FIG. 6), then a surface emission laser light can be obtained generating in the upper vertical direction in the plane of the sheet (see the arrow B in FIG. 6).

The external excitation light source unit 15 comprises a light source for excitation 16, an attenuator 17 constituted by an ND filter, a shutter 18 and lens 19 for condensing light from the external excitation light source on the laser medium body 10.

As shown in FIG. 1, in the organic solid-state dye laser of the present invention, a laser light 12 is emitted when the laser medium body 10 is irradiated with an excitation light 11 from the external excitation light source 15.

For the thin film organic semiconductor 3 used in the present invention, use is made of a laser material which is high in emission quantum yield and in which there is no or little excitation absorption at an excitation level and as the laser material use may conveniently be made of either a bis-styryl derivative expressed by general formula (1) or a triphenylamine derivative expressed by general formula (2), as mentioned below. The bis-styryl or the triphenylamine derivatives may be added to a host molecule. In the present invention, that there is no or little excitation absorption at an excitation level is referred to generally as that there is substantially no excitation absorption at an excitation level in the thin film of organic semiconductor 3.

The thin film of organic semiconductor 3 is preferably of a material whose quantum yield in photo luminescence (PL absolute quantum efficiency, hereinafter referred to as Φ_{PL}), namely emission quantum yield is high. The laser medium body is preferably of a material whose kᵣ is large. Further, in order to reduce the threshold value (Eₜₕ) for amplified spontaneous emission, a raise in fluorescent quantum yield and a reduction in fluorescence lifetime are necessary.

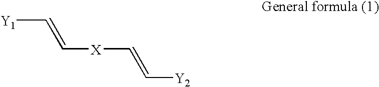

where Y₁, X and Y₂ are each a substituent of an aromatic or aliphatic compound and preferably the former. Y₁ may be equal to Y₂.

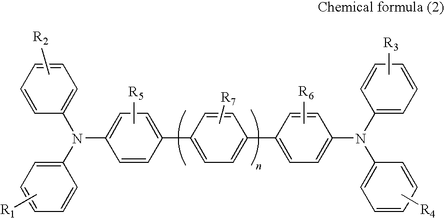

where R₁ to R₇ are each an alkyl radical and n=0, 1, 2, . . . .

The X may be a substituent such as 4,4′-biphenylene; 1,4-phenylene; 2,5-dicyano-1,4-phenylene; or 2,5-methoxy-1,4-phenylene.

Y₁ and Y₂ may each be a substituent such as carbazole; 4-[phenyl(3-methylphenyl)]aminophenyl]; 4-[di(4-methylphenyl)]aminophenyl; or 4-[di(4-methoxyphenyl)]aminophenyl.

The bis-styryl derivative above may be BSB-Cz (4,4′-bis[(N-carbazole)styryl]biphenyl) expressed by chemical formula (3) below. This bis-styryl derivative in chemical formula (1) above has X of 4,4′-biphenylene and Y₁═Y₂ of carbazole.

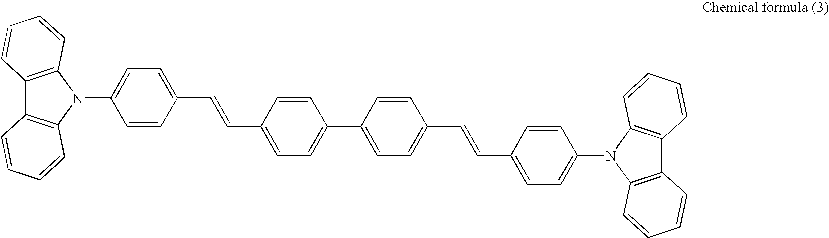

The bis-styryl derivative may also be C48H40N2 (Benzen-amine; 4,4′-(1,4-phenylenedi-2,1-ethenediyl)bis[N-(3-methyl-phenyl)-N-phenyl-(9Cl)) expressed by chemical formula (4) below. In chemical formula (1) above, this bis-styryl derivative has X of 1,4-phenylene and Y₁═Y₂ of 4-[phenyl(3-methylphenyl)]aminophenyl.

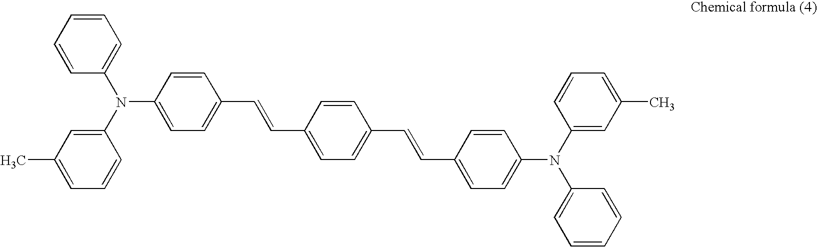

The bis-styryl derivative may also be C50H44N2 (4-(Di-p-Tolylamino)-4′-[(di-p-tolylamino)styryl]stilbene) expressed by chemical formula (5) below. In chemical formula (1) above, this bis-styryl derivative has X of 1,4-phenylene and Y₁═Y₂ of 4-[di(4-methylphenyl)]aminophenyl.

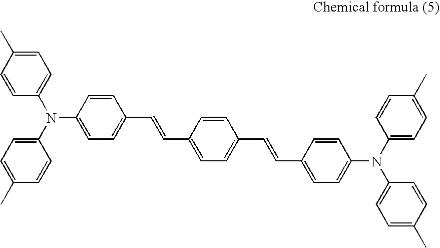

The bis-styryl derivative may also be C52H42N4O4 (1,4-Benzenedicarbonitrile 2,5-bis[2-[4-[bis(4-methoxyphenyl)amino]phenyl]ethenyl]-(9CI)) expressed by chemical formula (6) below. In chemical formula (1) above, this bis-styryl derivative has X of 2,5-dicyano-1,4-phenylene and Y₁═Y₂ of 4-[di(4-methoxyphenyl)]aminophenyl.

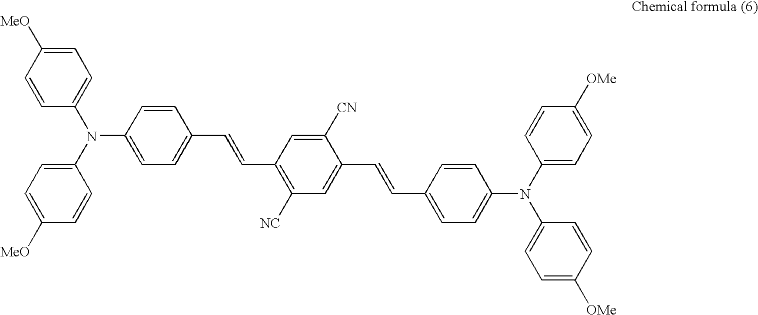

The bis-styryl derivative may also be C50H44N202 (1,4-dimethoxy-2,5-bis[p-(N-phenyl-N-(m-tolyl) amino)-styryl]-benzene; (BSB-OMe)) expressed by chemical formula (7) below. In chemical formula (1) above, this bis-styryl derivative has X of 2,5-methoxy-1,4-phenylene and Y₁═Y₂ of 4-[phenyl(3-methyl-phenyl]aminophenyl.

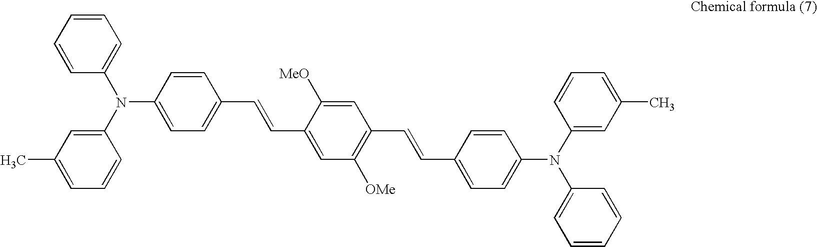

The bis-styryl derivative may also be C55H46N2 (4,4′-bis[4-(di-p-tolylamino)styryl]biphenyl) expressed by chemical formula (8) below. In chemical formula (1) above, this bis-styryl derivative has X of 4,4′-biphenylene and Y₁═Y₂ of 4-[di(4-methylphenyl]aminophenyl.

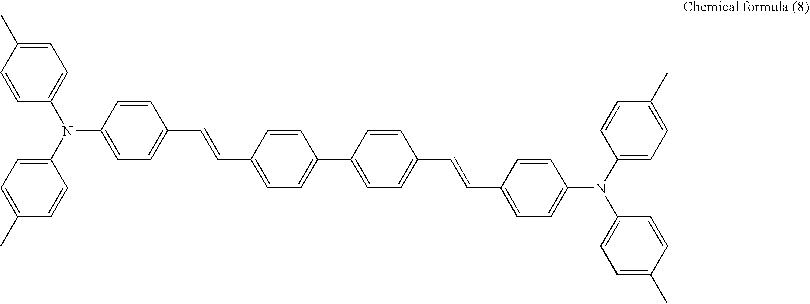

Instead of a bis-styryl derivative, a triphenylamine may be used. The triphenylamine may be N,N′-bis(3-methylphenyl))-N,N′-diphenyl-(1-1′-biphenyl)4,4′-diamine (N,N′-diphenyl-N,N′-(3-methylphenyl)-1,1′-biphenyl)-4,4′-diamine; also called “TPD”) expressed by chemical formula (9) below.

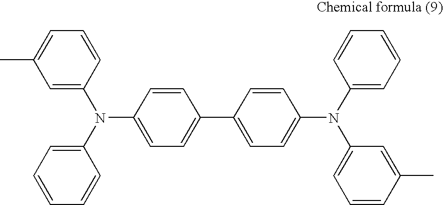

BSB-Cz has a PL absolute quantum efficiency: Φ_{PL}=99±1% and an oscillation wavelength (λ_{ASE}) of 461 nm for its amplified spontaneous emission. With Eₜₕ=0.32±0.1 μJ/cm², it is an organic semiconductor which is the lowest in threshold value of fluorescent materials of styryl family which have so far been examined. And, exhibiting no temperature dependence for its PL intensity and emission lifetime, it has been found that this material has its radiationless deactivation restrained.

Exhibiting its fluorescence lifetime τ_{f} as extremely short as τ_{f}=1.0±0.01 ns, it has been confirmed that it is an ultimate material, having a fluorescent quantum yield of 100%. It has also been found that its radiation deactivation velocity constant kᵣ reaching about 1×10⁹ s⁻¹, the material has an extremely high velocity constant.

TPD has a PL absolute quantum efficiency: Φ_{PL}=41% and an oscillation wavelength (λ_{ASE}) of 421 nm for its amplified spontaneous emission. And, exhibiting no temperature dependence for its PL intensity and emission lifetime, it has been found that this material has its radiationless deactivation restrained.

Exhibiting its fluorescence lifetime τ_{f} as extremely short as τ_{f}=0.6 ns, it has been confirmed that it is an ultimate material, having a fluorescent quantum yield of 100%. It has also been found that its radiation deactivation velocity constant kr reaching about 6.8×10⁸ s⁻¹, the material has an extremely high velocity constant.

BSB-Cz or TPD may each be doped into CBP (4,4′-N,N′-dicarbazole-biphenyl) as the organic semiconductor material expressed by chemical formula (10), namely where CBP constitutes a host molecule while BSB-Cz or TPD constitutes a guest molecule. The host molecule should be of a material that is larger in band gap than that of the guest molecule. Then, the lower the dopant concentration in the host molecule of BSB-Cz, the more is the concentration quenching restrained and hence the higher becomes the emission efficiency. On the other hand, the gain of laser medium increases in proportion to the dopant concentration and may thus be chosen at an optimum value. In this case, the concentration of BSB-Cz or TPD ranges between 1 and 20% by weight and is preferably between 3 to 10% by weight and most preferably 6% by weight.

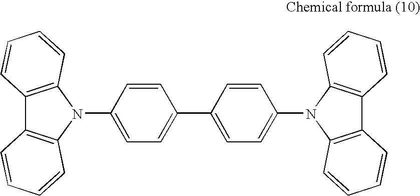

Here, the thin film of organic semiconductor 3 may be deposited on the substrate 2 by a standard thin-film growth method such as vapor deposition, sputtering, CVD, laser ablation or MBE, or by a wet film-forming method using a spinner or an ink jet. In the process of masking for forming a pattern for the waveguide or diffraction grating of a predetermined shape, light exposure, EB exposure or the like may be used. Also, the diffraction grating may be grooved by one of various etching processes.

According to the organic solid-state dye laser 1 of the present invention, ASE is created by its irradiation from the excitation light source 16 in the external excitation light source unit 15. In the present invention, a laser light is obtained under excitation by continuous waves, since an organic semiconductor material that is high in emission quantum yield and in which there is substantially no excitation absorption at an excitation level is used. The excitation light source 16 used may be one of various lasers. The continuous wave excitation light source 16 may, for example, be a He—Cd laser or semiconductor laser diode. If the excitation light source 16 used is of continuous wave (CW), the organic solid-state dye laser 1 becomes a CW laser.

In the structure of the organic solid-state dye laser according to the present invention, the components such as the lens 19 shown in FIG. 1 as individual parts can be small size parts such as a micro lens. Also, these component parts can be integrated together with the laser medium body 10 on the substrate to make the apparatus small-sized.

### Example 1

The present invention is further described in detail on the basis of specific examples.

A method of preparing BSB-Cz used in the organic solid-state dye laser 1 of the present invention is mentioned first.

BSB-Cz was synthesized according to chemical formula (11) below.

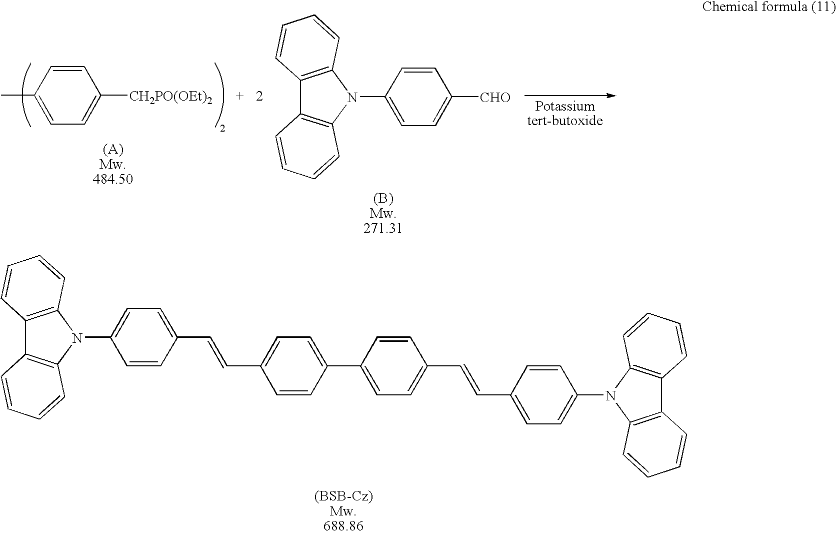

First, 0.581 g (0.00129 mol) of [1,1-biphenyl]-4,4′-diyl bis(methylene)bis-tetraethyl phosphonate ester of (A) and 0.771 g (0.00284 mol) of 4-(9H-carbazole-9yl)-benzaldehyde were mixed into 60 cm³ of DMF (dimethyl formamide) as an organic solvent, and the mixed solution was stirred in a nitrogen atmosphere.

0.4 g of potassium tert-butoxide ((CH₃)₃ COK) was added to solution above and further DMF was added to give rise to a total volume of about 200 cm³. The resultant solution was cooled by ice and stirred for 15 minutes.

Next, the solution above was neutralized with acetic acid (CH3COOH) and filtered. The filtered product was washed with 500 cm³ of pure water to obtain 1.15 g of a yellow-green powder (at a yield of 140%). The powder was dried in vacuum at 80° C. to synthesize BSB-Cz in 0.66 g (at a yield of 80%). And, 0.66 g of was purified by sublimation at 340° C. to finally obtain 0.55 g of high purity BSB-Cz (at a yield of 66%).

### Example 2

As TPD, a chemical product on the market was used.

### Comparative Example

Mention is next made of a comparative example.

A thin film of organic semiconductor prepared by adding 6% by weight of BSB-Me expressed by chemical formula (12) to host CBP molecule was used as the laser medium.

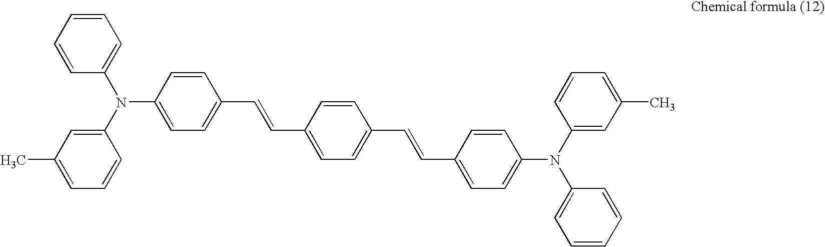

Mention is next made of light absorption characteristics of BSB-Cz and TPD above.

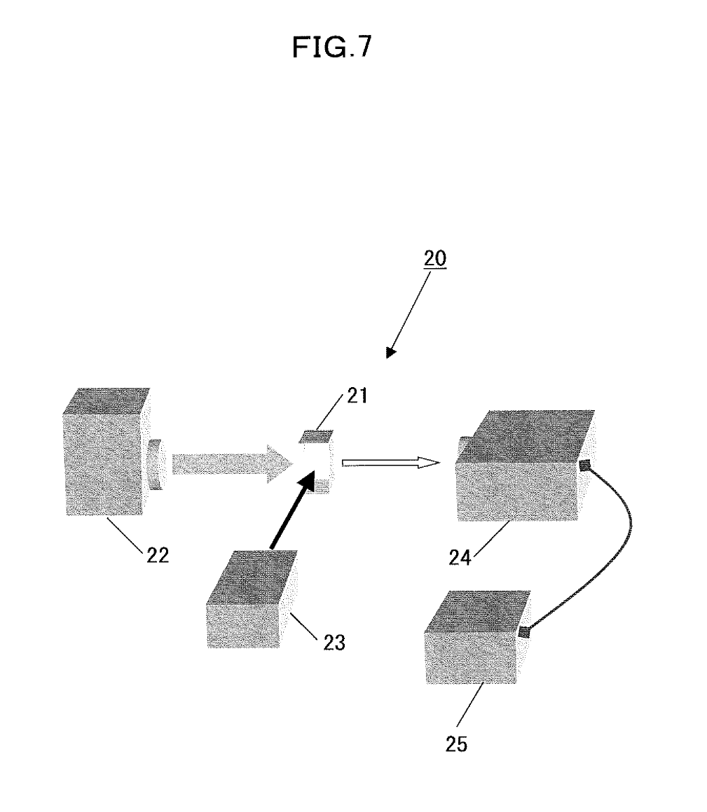

Excitation absorption characteristics were measured of organic semiconductors such as BSB-Cz and TPD. FIG. 7 is a view diagrammatically illustrating an equipment for measuring excitation absorption characteristics of organic semiconductors.

As shown in FIG. 7, the equipment 20, for measuring excitation absorption characteristics of an organic semiconductor comprises a reference light source 22 for irradiating a sample of organic semiconductor 21 with a light propagating in a direction from left to right, an excitation light source 23 for exciting the specimen 21, a spectrometer 24 on which the light transmitted through the specimen is incident and a detecting means 25 for detecting a transient signal detected at the spectrometer 24. The specimen 21 used can be a solution in which a material that becomes the thin film of organic semiconductor is dissolved with an organic solvent. The organic solvent used was tetrahydro furan (THF) and the concentration of the solution was adjusted so that its optical density at an excitation wavelength becomes 1 to 2. The reference light source 22 used was a xenon (Xe) lamp (made by Hamamatsu Photonics Co., Ltd., model L8004) with an output of 150 W which is a white continuous light source. The excitation light source 23 used was a pulse laser of Nd³⁺: YAG (made by Spectra-Physics; model INDI-40-10-HG) whose third harmonic (wavelength of 355 nm) was used. The detecting means 25 used can be one that is capable of detecting electric signals on the time domain and, e. g. an oscilloscope or the like. Excitation absorption characteristics of the specimen 21 made of an organic semiconductor can be found by irradiating it with continuous white color light from the source 22 in synchronized with excitation light from the pulse laser 23 as the excitation light source and measuring changes of absorption light with time. In the change of absorption light with time that damps, the shorter in time indicates the singlet-singlet absorption and the longer in time indicates the triplet-triplet absorption.

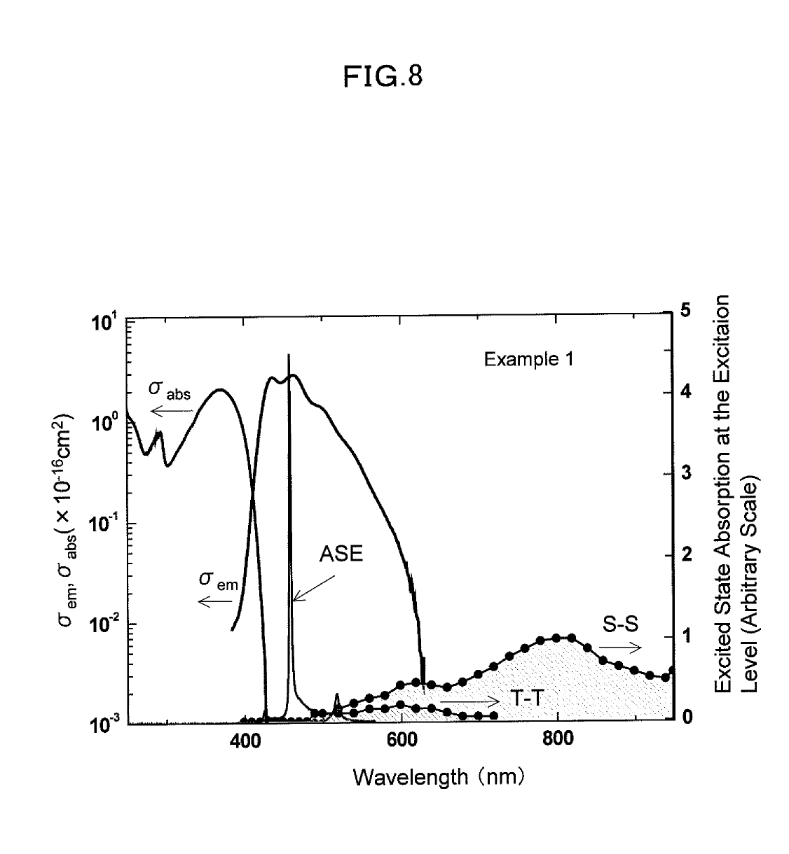

FIG. 8 is a graph illustrating characteristics of light absorption cross section σ_{abs}, stimulated emission cross section σₑₘ and excitation absorption at an excitation level of BSB-Cz used in Example 1 of the present invention. In the graph, the abscissa axis represents the wavelength (in nm), the ordinate axis on the left hand side represents the light absorption cross section σ_{abs} and the stimulated emission cross section σₑₘ (both in 10¹⁶ cm²) and the ordinate axis on the right hand side represents the excitation absorption characteristics at an excitation level(in arbitrary scale). The graph also shows an ASE spectrum in Example as will be described later.

As is apparent from FIG. 8, it is seen that BSB-Cz shows the light absorption cross section σ_{abs} growing large with wavelengths less than about 400 nm and the stimulated emission cross section σₑₘ growing large in the vicinity of an ASE emission wavelength. It is also found that it shows its excitation absorption characteristics at an excitation level that there is little excitation absorption in the excitation level of singlet-singlet (see S-S in FIG. 8) or of triplet-triplet (see T-T in FIG. 8) in the vicinity of an ASE peak wavelength of 462 nm.

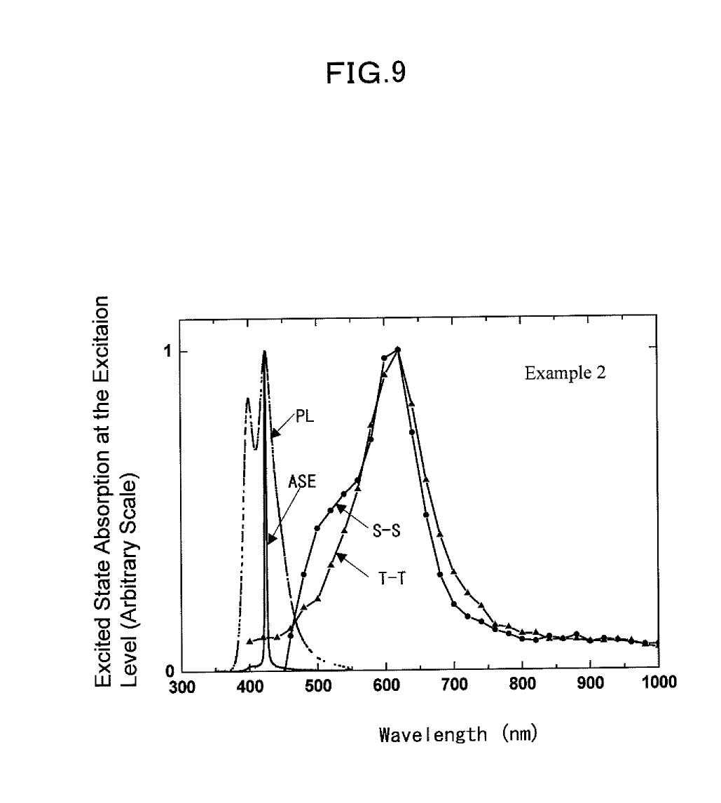

FIG. 9 is a graph illustrating excitation absorption characteristics at an excitation level of TPD used in Example 2 of the present invention. In the graph, the abscissa axis represents the wavelength (in nm) and the ordinate axis represents the excitation absorption characteristics at an excitation level (in arbitrary scale). The graph also shows a PL and an ASE spectrum in Example 2 as will be described later.

As is apparent from FIG. 9, it is seen that TPD has its excitation absorption characteristics at an excitation level that there is little excitation absorption in the excitation level of singlet-singlet (see S-S in FIG. 9) or of triplet-triplet (see T-T in FIG. 9) in the vicinity of an ASE peak wavelength of 425 nm.

An example of the organic solid-state dye laser of the present invention will be mentioned next.

A thin film of organic semiconductor 3 with BSB-Cz or TPD as a guest molecule and CBP as a host molecule as described in Examples 1 and 2 was formed by vapor co-deposition on a substrate 2 of quartz glass having a thickness of 1.1 mm. BSB-Cz or TPD had various concentrations varied from 1 to 20% by weight and the film had various thicknesses varied from 100 nm to 500 nm. Formed with films, substrates 2 of quartz glass were each cut into a size of 5 mm×25 mm as a laser medium body 10. The excitation light source 16 in the excitation light source unit 15 used was a continuous wave He—Cd laser (with a wavelength of 325 nm).

Various properties of the organic solid-state dyer lasers of the Examples will be mentioned next.

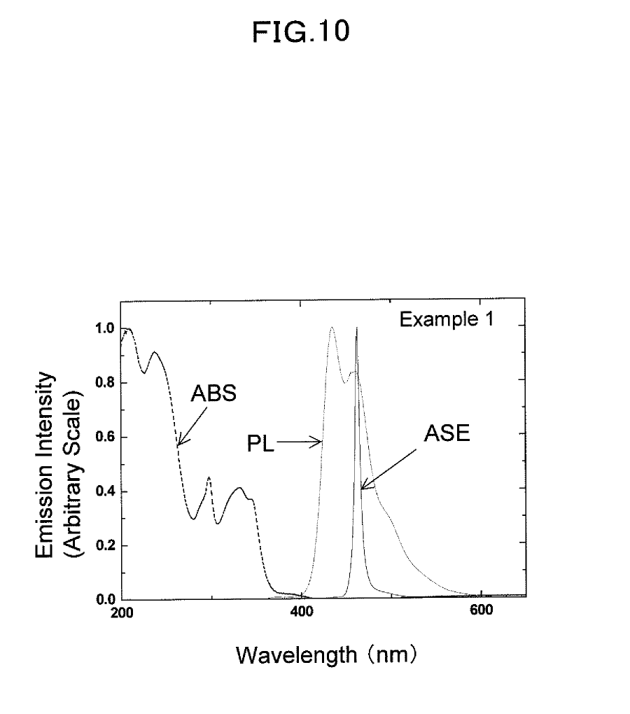

FIG. 10 is a graph illustrating an absorption light characteristic of the organic solid-state dye laser having a film thickness of 100 nm in Example 1, its photoluminescence spectrum and its emission spectrum under external excitation light. In the graph, the abscissa axis represents the normalized absorption or emission wavelength (in nm) and the ordinate axis represents the absorbance or emission strength (in arbitrary scale). The irradiation with an external excitation light was performed under a nitrogen atmosphere. The pulsed excitation light source 16 used for the external excitation light was a nitrogen gas laser (337 nm) with a pulse width of 500 ps and a repetition rate of 10 Hz.

As is apparent from FIG. 10, the organic solid-state dye laser 1 with a film thickness of 100 nm shows light absorption with a wavelength of about 400 nm or less, and its PL peak wavelength (λ_{FLU}) was 435 nm. It is shown that the amplified spontaneous emission is generated by a pulsed excitation as will be described later and the ASE peak wavelength (λ_{ASE}) is 463 nm.

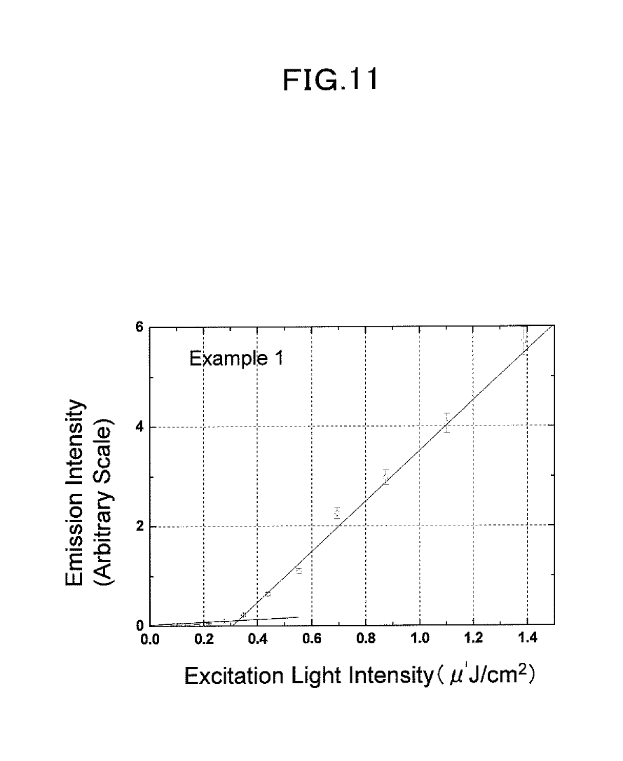

FIG. 11 is a graph illustrating dependence upon excitation light intensity, of emission light intensity of the organic solid-state dye laser having a film thickness of 100 nm in Example 1 under pulsed excitation by a nitrogen gas laser. In the graph, the abscissa axis represents the excitation light intensity (in μJ/cm²) and the ordinate axis represents emission light intensity (in arbitrary scale) at 463 nm.

As is apparent from FIG. 11, it is seen that the ASE was generated in the pulsed nitrogen gas laser and its emission threshold value was 0.32 μJ/cm². It is also shown that the thin film of organic semiconductor 3 with BSB-Cz as its guest molecule and CBP as its host molecule shows a PL absolute quantum efficiency as Φ_{PL}=99±1% and a short value of fluorescence lifetime as τ_{f}=1.0 ns.

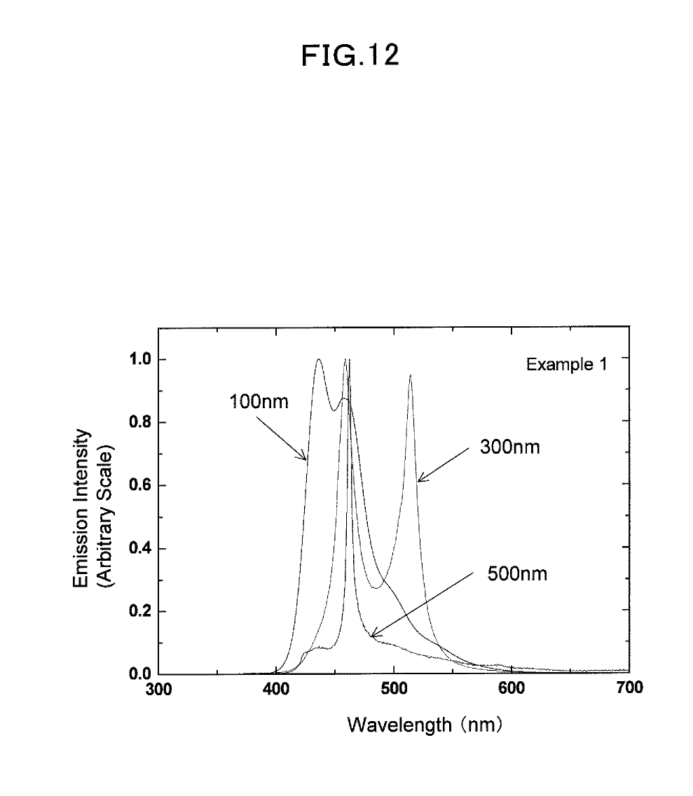

FIG. 12 is a graph illustrating emission spectra of the organic solid-state dye lasers of varied film thicknesses in Example 1, excited by external light. In the graph, the abscissa axis represents the emission wavelength (in nm) and the ordinate axis represents the emission light intensity (in arbitrary scale). Irradiation with an external excitation light was performed under a nitrogen atmosphere and the light source 16 used for the external excitation light was a CW He—Cd laser (325 nm) with output power of 10 mW. The intensity of the excitation light was adjusted by the attenuator filter 17.

As is apparent from FIG. 12, it is shown that with the exciting CW He—Cd laser 16, ASEs were generated in the thin films of semiconductor 3 and their emission spectra have extremely sharp peaks of emission wavelength as they have film thicknesses of 100 nm, 300 nm and 500 nm.

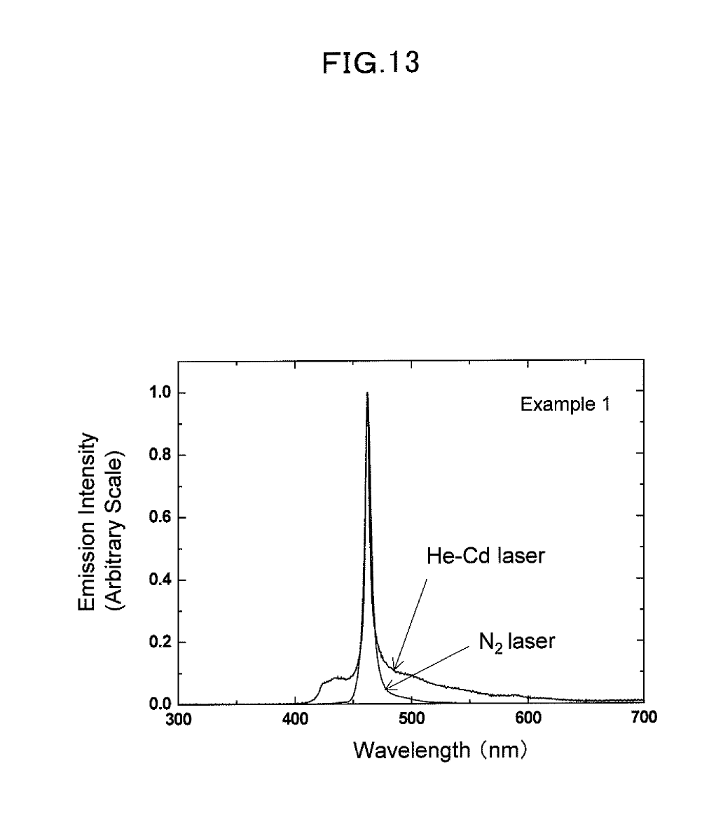

FIG. 13 is a graph illustrating emission spectra of the organic solid-state dye laser 1 of a film thickness of 500 nm in Example 1, excited by external light. In the graph, the abscissa axis represents the emission wavelength (in nm) and the ordinate axis represents the emission light intensity (in arbitrary scale). Each irradiation with an external excitation light was performed under a nitrogen atmosphere. The excitation light source 16 used for a pulsed external excitation light was the nitrogen gas laser (337 nm) with a pulse width of 500 ps and a repetition rate of 10 Hz, and the excitation light source 16 used for a CW external excitation light was the CW He—Cd laser (325 nm) with output power of 10 mW.

As is apparent from FIG. 13, it is shown that with the organic solid-state dye laser 1 in Example 1 when excited by the pulsed nitrogen gas laser and the CW He—Cd laser, intense emissions are obtained at peak wavelengths of 463 nm and 462 nm, respectively.

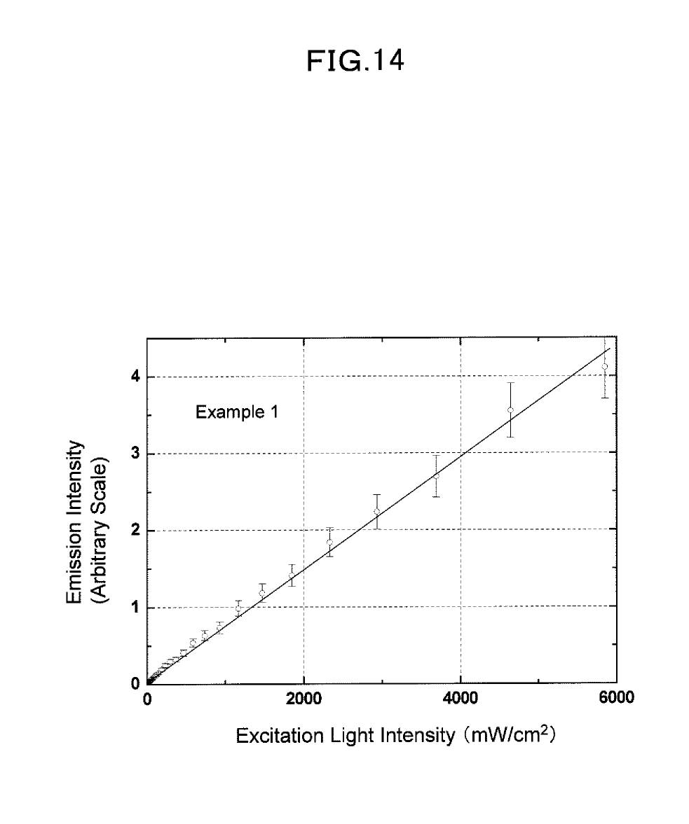

FIG. 14 is a graph illustrating dependence upon excitation light intensity, of emission light intensity of the organic solid-state dye laser 1 of a film thickness of 500 nm in Example 1 under excitation by the CW He—Cd laser. In the graph, the abscissa axis represents the excitation light intensity (in mW/cm²) and the ordinate axis represents the emission light intensity (in arbitrary scale) at an emission wavelength of 462 nm. As is apparent from FIG. 14, it is seen that the emission light intensity increases in proportion of the excitation light intensity of the CW He—Cd laser 16 as the latter increases to 6000 mW/cm² (6 W/cm²).

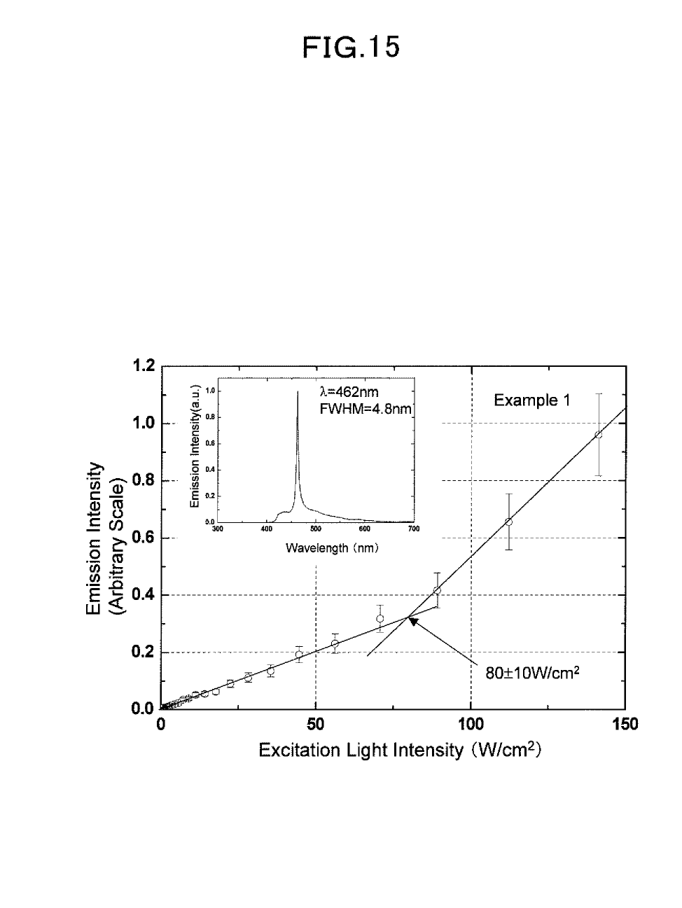

FIG. 15 is a graph illustrating dependence of emission light intensity upon excitation light intensity at a higher excitation intensity side further to that in FIG. 14. In the graph, the abscissa axis represents the excitation light intensity (in W/cm²) and the ordinate axis represents the emission light intensity (in arbitrary scale) at an emission wavelength of 462 nm.

As is apparent from FIG. 15, it is shown that with the excitation light intensity of the CW He—Cd laser 16 exceeding about 100 W/cm², the emission light intensity markedly increases, generating about an amplified spontaneous emission or ASE. The ASE has a threshold value which is 80±10 W/cm² as it is found at where the emission intensity line at the lower excitation light side intersects with the emission intensity line in the region where the ASE is generated.

Further, the inserted graph in FIG. 15 is a graph illustrating an ASE spectrum at an excitation light intensity of 140 W/cm². From this inserted graph, it is seen that the emission wavelength for the ASE is 462 nm where an extremely sharp peak is observed whose full width at half maximum (FWHM) is 4.8 nm. For threshold values of this ASE, the energy density was 80 W/cm² and the output of excitation light was 3 mW. No ASE, namely no laser emission, has ever been reported under such low excitation energy that is of the lowest value as in an organic solid-state dye laser to the best of knowledge of the present inventors.

Measurement was next made of polarization characteristics at ASE of an organic solid-state dye laser with a film thickness of 500 nm in the Examples.

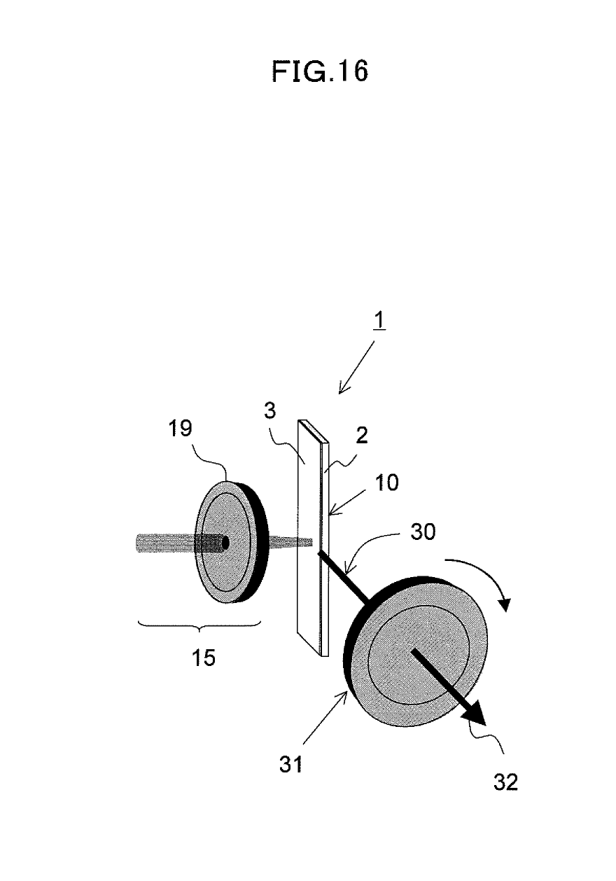

FIG. 16 is a view diagrammatically illustrating a method of measuring polarization characteristics. As shown in the Figure, a light polarizer 31 that is disposed on the light outgoing optical path side 30 is rotated (in the direction of arrow in FIG. 16) to measure the intensity of ASE light 32 which is then polarized.

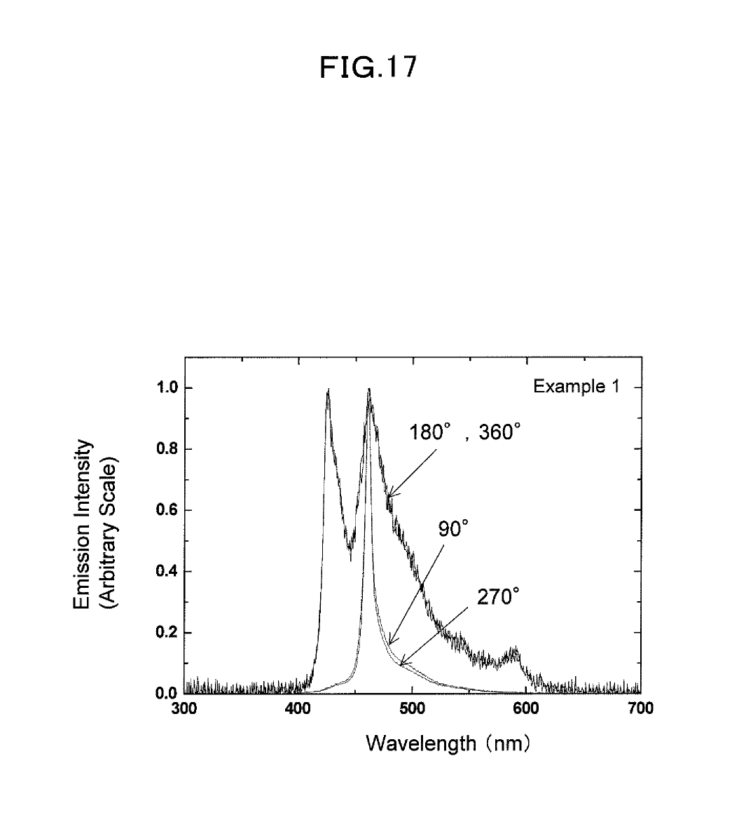

FIG. 17 is a graph illustrating polarization characteristics of ASE of the organic solid-state dye laser of a film thickness of 500 nm in Example 1 under excitation by the CW He—Cd laser. In the graph, the abscissa axis represents the light emission wavelength (in nm) and the ordinate axis represents the normalized light emission intensity at an ASE emission wavelength of 462 nm (in arbitrary scale).

As is apparent from FIG. 17, when the polarizer was angled at 90° and 270°, much sharper peaks were observed than when it was angled at 180° and 360°. And, the ratio in emission intensity of when the polarizer was angled at 90° to when it was angled at 180° was 18:1 and the emission was higher in output intensity with the polarizer at an angle of 90°.

These light emissions were found to be in a TE mode and to agree with the mode for a waveguide, too. Since the peak wavelengths as do ASE emission wavelengths under pulsed excitation correspond to the 0-1 transition in BSB-Cz, it has been found that an organic solid-state dye laser 1 in Example 1 generates the ASE emission under CW excitation.

Mention is made of various properties of an organic solid-state dye laser in Example 2.

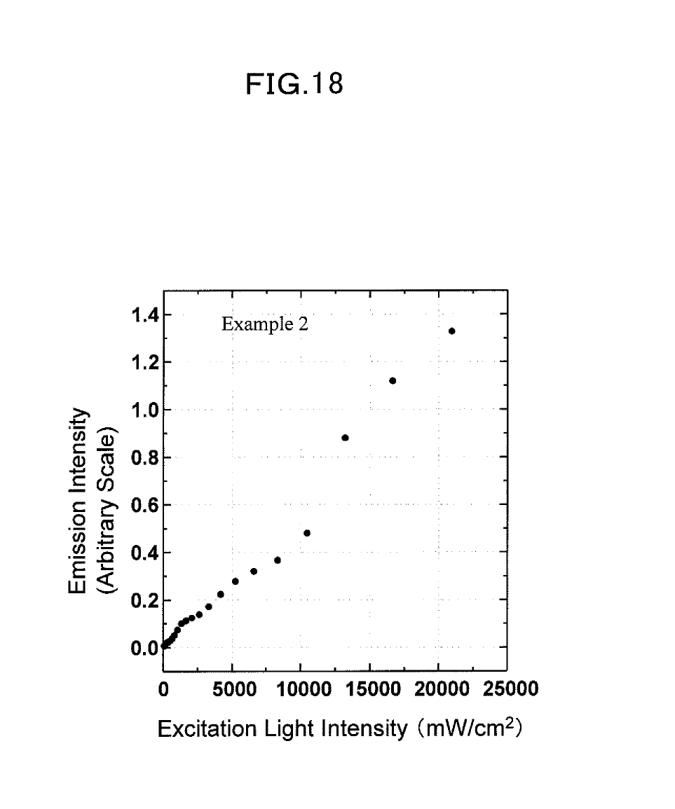

FIG. 18 is a graph illustrating dependence upon excitation light intensity, of emission light intensity of the organic solid-state dye laser 1 in Example 2 excited by the He—Cd continuous wave laser. In the graph, the abscissa axis represents the excitation light intensity (mW/cm²) and the ordinate axis represents the emission light intensity at an emission wavelength of 421 nm.

As is apparent from FIG. 18, it is shown that the emission light intensity increases in proportion to the excitation light intensity of the He—Cd continuous wave laser 16 as the latter increases to about 10,000 mW/cm² (10 W/cm²), and markedly increases so as it exceeds about 10 W/cm², namely generating the amplified spontaneous emission or ASE. The emission threshold vale for the ASE was about 10 W/cm² and the excitation light output was 3 mW. It is shown that the emission threshold value for ASE in Example 2 is about one tenth ( 1/10) of that in Example 1.

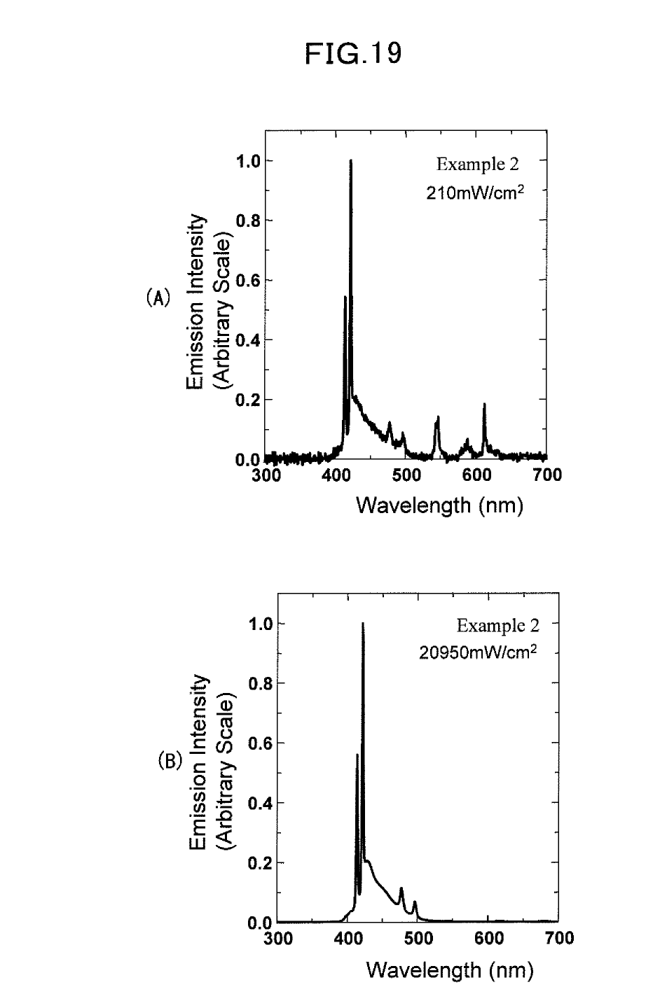

FIG. 19 shows emission spectra of the organic solid-state dye laser 1 in Example 2 shown in FIG. 18 when the excitation light intensity is (A) 210 mW/cm² and (B) 20950 mW/cm² (about 21 W/cm²), respectively. In the graph, the abscissa axis represents the emission light wavelength (in nm) and the ordinate axis represents the emission light intensity (in arbitrary scale).

As is apparent from FIG. 19, it is shown that the organic solid state dye laser 1 in Example 2 has an intense light emission at an emission intensity peak wavelength of 421 nm both when the excitation light intensity of the CW He—Cd laser was 210 mW/cm² and when it is 20,950 mW/cm². When the excitation light intensity is 20,950 mW/cm², it has been found that no radiation in excess of about 500 nm of wavelength comes to be observed in the system, compared with the case of 210 mW/cm², increasing its spectral purity.

Mention is next made of characteristics of light emission of the organic semiconductor in the Comparative Example under external light excitation.

When the organic semiconductor as in the Examples was irradiated with the CW He—Cd laser in the Comparative Example, however, no dependence of the light emission intensity on the excitation light intensity was then observed, showing that no ASE was generated.

Comparison of Examples 1 and 2 with Comparative Example above indicates the organic semiconductor thin film 2 with BSB-Cz or TPD when contained as its component at a proportion of 2 to 20% by weight, especially 6% by weight in the host molecule gives rise to amplified spontaneous emission at a low emission threshold value. Also, when said organic semiconductor thin film is thicker, the ASE can easily have a waveguide structure.

It should be understood that the present invention is not limited to the specific forms of implementation described above and allows various modifications within the scope of the invention set forth in the Claims and which needless to say are encompassed in the present invention. For example, while in the embodiments a waveguide structure is used, it may be a resonator structure using a diffraction grating in any one of various forms made of a thin film of the specific organic semiconductor.

What is claimed is:

1. An organic solid-state dye laser comprising a substrate and a resonator structure made of a thin film of organic semiconductor formed on the substrate, characterized in that said thin film of organic semiconductor is composed of an organic semiconductor material which is high in emission quantum yield and substantially devoid of excitation absorption at an excitation level and includes one of a bis-styryl derivative expressed by general formula (1) and a triphenylamine derivative expressed by general formula (2), whereby its amplified spontaneous emission under excitation light irradiation is continuously obtained wherein: 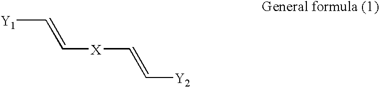
where Y₁, X and Y₂ are each a substituent of an aromatic or aliphatic compound, and 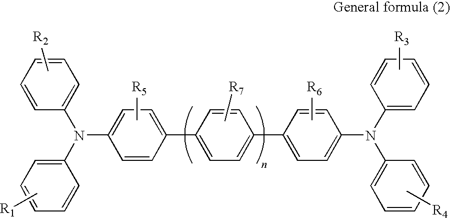
where R₁ to R₇ are each an alkyl radical and n is an integer of 0 or over.

2. The organic solid-state dye laser as set forth in claim 1 in which said resonator structure made of the thin film of organic semiconductor is constituted by a waveguide or a diffraction grating.

3. The organic solid-state dye laser as set forth in claim 1 in which said bis-styryl derivative is BSB-Cz (4,4′-bis[(N-carbazole)styryl]biphenyl).

4. The organic solid-state dye laser as set forth in claim 1 in which said triphenylamine derivative is TPD (N,N′-diphenyl-N,N′-(3-methylphenyl)-1,1′-biphenyl)-4,4′-diamine).

5. The organic solid-state dye laser as set forth in any one of claims 1, 3 and 5 in which said bis-styryl derivative or triphenyl amine derivative is added to a host molecule.

6. The organic solid-state dye laser as set forth in claim 5 in which said host molecule is CBP (4,4′-N,N′-dicarbazole-biphenyl).
